(19) United States
(12) Patent Application Publication
(10) Pub. No.: US 2025/0320405 A1
(43) Pub. Date: Oct. 16, 2025

(54) GELLED ACID COMPOSITIONS AND METHODS FOR ACID STIMULATION IN CARBONATE FORMATIONS

(71) Applicants: SAUDI ARABIAN OIL COMPANY, Dhahran (SA); KING FAHD UNIVERSITY OF PETROLEUM & MINERALS, Dhahran (SA)

(72) Inventors: Mahmoud Hassan DESOUKY, Dhahran (SA); Murtada Saleh ALJAWAD, Dhahran (SA); Murtadha J. ALTAMMAR, Dhahran (SA); Khalid Mohammed ALRUWAILI, Dhahran (SA)

(73) Assignees: SAUDI ARABIAN OIL COMPANY, Dhahran (SA); KING FAHD UNIVERSITY OF PETROLEUM & MINERALS, Dhahran (SA)

(21) Appl. No.: 18/634,507

(22) Filed: Apr. 12, 2024

(51) Int. Cl. C09K 8/76

(52) U.S. Cl. CPC C09K 8/76

(57) ABSTRACT

Methods for acid stimulation in carbonate formations using gelled acid compositions may comprise injecting a gelled acid composition having a viscosity of about 25 cP to about 40 cP into a carbonate formation, wherein the gelled acid composition comprises diammonium phosphate (DAP), an acid, a thickening agent, a crosslinker, and water; and acidizing the carbonate formation with the gelled acid composition to increase a permeability of the carbonate formation.

### FIELD OF THE DISCLOSURE

The present disclosure relates generally to compositions and methods for treating oil and gas reservoirs and, more particularly, to acid stimulation of carbonate formations.

### BACKGROUND OF THE DISCLOSURE

Acid stimulation in carbonate formations of oil and gas reservoirs is a complex and critical process, primarily due to the unique challenges posed by the intricate mineralogy and pore structure of these formations. Carbonate rocks, composed mainly of minerals such as calcite, dolomite, and aragonite, are characterized by a diverse and complex pore system, which includes interparticle, intraparticle, moldic, vuggy, and fracture porosities. This heterogeneity makes achieving effective acid penetration and distribution a significant challenge. The goal of acid stimulation in such environments is to enhance the permeability of the rock by dissolving parts of the formation, thereby creating channels that facilitate the flow of hydrocarbons.

In response to these challenges, gelled acid compositions have been developed and used in the acid stimulation process. These gelled acids, essentially comprising conventional acidizing fluids mixed with a gelling agent, have a higher viscosity compared to traditional acid solutions. The increased viscosity of gelled acids offers better control over the placement and retention of the acid in the reservoir, aiding in achieving a more uniform distribution across the treatment zone. This may be especially beneficial in the heterogeneous environments of carbonate formations, in which lower viscosity acids may channel through the formation, leading to inefficient stimulation.

However, the viscosity of these gelled acid compositions may not be sufficient to adequately acidize carbonate formations, particularly in more complex or highly heterogeneous reservoirs. Additionally, the viscosity of gelled acids may decrease over time due to various factors such as temperature changes or reactions with the formation minerals. This decrease in viscosity can lead to reduced control over the acid placement and distribution, potentially reverting back to the challenges faced with lower viscosity acids. As a result, while gelled acids represent an advancement in acid stimulation technology, their application requires careful planning and monitoring to ensure that they retain their advantageous properties throughout the stimulation process.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, methods for acid stimulation in carbonate formations using gelled acid compositions may comprise injecting a gelled acid composition having a viscosity of about 25 cP to about 40 cP into a carbonate formation, wherein the gelled acid composition comprises diammonium phosphate (DAP), an acid, a thickening agent, a crosslinker, and water; and acidizing the carbonate formation with the gelled acid composition to increase a permeability of the carbonate formation.

In another embodiment, gelled acid compositions for acid stimulation in carbonate formations may comprise diammonium phosphate (DAP); an acid; a thickening agent; a crosslinker; and water, wherein the compositions have a viscosity of about 25 cP to about 40 cP.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic drawing of a wellbore illustrating the formation of cracks in a carbonate formation due to treatment with a gelled acid composition.

FIG. 2 is a graph of the time-dependent viscosities of a comparative gelled acid composition and an example gelled acid composition of the present disclosure.

### DETAILED DESCRIPTION

Embodiments in accordance with the present disclosure generally relate to compositions and methods for treating oil and gas reservoirs and, more particularly, to acid stimulation of carbonate formations. As previously discussed, the viscosity of gelled acid compositions used in oil and gas reservoirs may be highly variable, subject to the distinct conditions within each well. This variability may lead to uneven performance outcomes, possibly resulting in a decrease in the effectiveness of the acid stimulation process. To address this issue, there is a significant demand for more stable gelled acid formulations that consistently maintain or enhance viscosity, thereby improving the overall effectiveness of the stimulation.

The present disclosure introduces gelled acid compositions comprising diammonium phosphate (DAP) as a component. DAP, having properties that may influence the rheological characteristics of solutions, may stabilize and enhance the viscosity of gelled acids. By enhancing the viscosity, the gelled acid compositions comprising DAP may offer more controlled and uniform acid distribution within the carbonate formations. This uniformity may ensure that the acid interacts effectively with the entire zone of interest, dissolving the carbonate minerals evenly and creating more effective pathways for hydrocarbons to flow. Additionally, the increased viscosity may contribute to reducing the rapid loss of acid to high-permeability zones or “thief zones,” which is a common challenge in carbonate formations.

A non-limiting example of a gelled acid composition may comprise: DAP; an acid; a thickening agent; a crosslinker; and water.

Without being bound by any particular theory, the presence of the DAP in the composition may produce a gelled acid composition having a higher viscosity than a gelled composition without DAP. Compositions of the present disclosure may have a viscosity of about 25 cP to about 40 cP, or about 25 cP to about 35 cP, or about 25 cP to about 30 cP, or about 30 cP to about 40 cP, or about 30 cP to about 35 cP, or about 35 cP to about 40 cP.

A non-limiting example of an acid stimulation method of the present disclosure may comprise: injecting a gelled acid composition having a viscosity of about 25 cP to about 40 cP into a carbonate formation; wherein the gelled acid composition comprises: DAP; an acid; a thickening agent; a crosslinker; and water; and acidizing the carbonate formation with the gelled acid composition to increase a permeability of the carbonate formation.

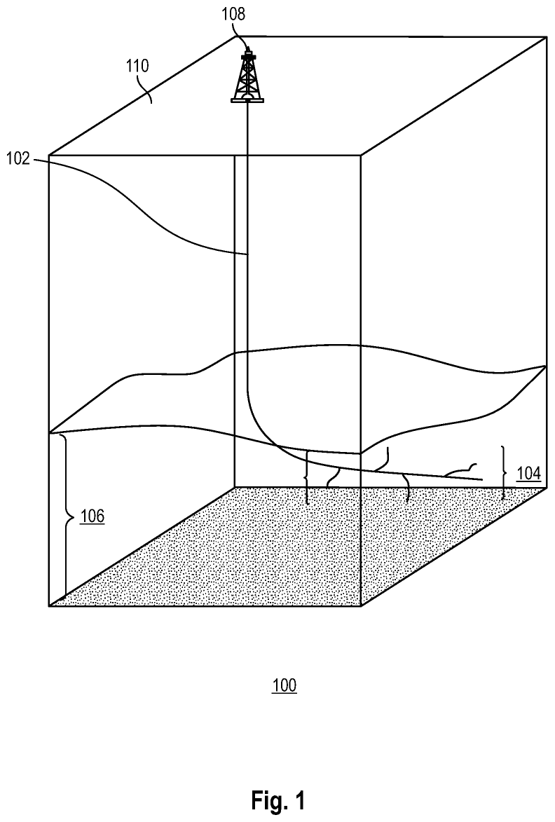

FIG. 1 is a schematic drawing 100 of a wellbore 102 illustrating the formation of cracks 104 in a carbonate formation 106 due to treatment with a gelled acid composition. The gelled acid composition may be provided to the carbonate formation 106 through the wellbore 102, for example, directly or through a smaller tubular such as a coiled tubing line. Apparatus 108 at the surface 110, such as tanks, pumps, coiled tubing lines, and the like is used to provide the gelled acid composition. As described herein, acid stimulation with strong mineral acids, such as hydrochloric acid, may result in a faster reaction with the carbonate reservoir 106, leading to less acid penetration. The gelled acid composition may provide further penetration during the reaction, increasing the effectiveness of the acid treatment in forming the cracks 104, thus increasing the permeability of the carbonate formation 106.

In any embodiment, the concentration of the DAP in the gelled acid composition may be varied to achieve a specific desired viscosity of the composition. Without being limited by theory, it is believed that the addition of more DAP to the composition may subsequently increase the gelled acid's viscosity. For example, the gelled acid composition may have a DAP concentration of about 1 wt % to about 20 wt %, or about 1 wt % to about 15 wt %, or about 1 wt % to about 10 wt %, or about 1 wt % to about 5 wt %, or about 5 wt % to about 20 wt %, or about 5 wt % to about 15 wt %, or about 5 wt % to about 10 wt %, or about 10 wt % to about 20 wt %, or about 10 wt % to about 15 wt %, or about 15 wt % to about 20 wt %.

The acid within the gelled acid composition may comprise hydrochloric acid, methanesulfonic acid (MSA), the like, and any combination thereof. Preferably, the acid may consist entirely of hydrochloric acid. For example, the gelled acid composition may have an acid concentration of about 5 wt % to about 25 wt %, or about 5 wt % to about 20 wt %, or about 5 wt % to about 15 wt %, or about 5 wt % to about 10 wt %, or about 10 wt % to about 25 wt %, or about 10 wt % to about 20 wt %, or about 10 wt % to about 15 wt %, or about 15 wt % to about 25 wt %, or about 15 wt % to about 20 wt %, or about 20 wt % to about 25 wt %.

One or more thickening agents may be present in the gelled acid composition to produce the gel structure of the composition. Suitable thickening agents may include, but are not limited to, biopolymers such as guar and/or xanthan derivatives, polysaccharides, synthetic polymers, the like, and any combination thereof. Preferably, the thickening agent may comprise a guar derivative. An example of a preferable guar derivative is carboxymethyl hydroxypropyl guar.

The thickening agent may be present in the gelled acid composition at a concentration high enough to give the desired consistency of the composition. For example, the gelled acid composition may have a thickening agent concentration of about 0.01 wt % to about 10 wt %, or about 0.01 wt % to about 5 wt %, or about 0.01 wt % to about 1 wt %, or about 0.01 wt % to about 0.1 wt %, or about 0.1 wt % to about 10 wt %, or about 0.1 wt % to about 5 wt %, or about 0.1 wt % to about 1 wt %, or about 1 wt % to about 10 wt %, or about 1 wt % to about 5 wt %, or about 5 wt % to about 10 wt %.

The thickening agent may be modified by the addition of a crosslinker. The crosslinker may react with the thickening agent to bind individual strands of the polymeric thickening agent. Suitable crosslinkers may include group 4 metal crosslinkers including, but not limited to, zirconium compounds, such as zirconium lactate, zirconium lactate triethanolamine, zirconium carbonate, zirconium acetylacetonate, zirconium maleate, zirconium citrate, zirconium oxychloride, zirconium alkoxide, and zirconium diisopropylamine lactate; titanium compounds, such as titanium lactate, titanium maleate, titanium citrate, titanium ammonium lactate, titanium triethanolamine, and titanium acetylacetonate; aluminum compounds, such as aluminum lactate or aluminum citrate; and colemanite; antimony compounds; chromium compounds; iron compounds; copper compounds; zinc compounds; the like; and combination thereof. Preferably, the crosslinker may comprise a zirconium-based crosslinker such as an alkanolamine chelate of zirconium alkoxide.

For example, the gelled acid composition may have a crosslinker concentration of about 0.01 wt % to about 10 wt %, or about 0.01 wt % to about 5 wt %, or about 0.01 wt % to about 1 wt %, or about 0.01 wt % to about 0.1 wt %, or about 0.1 wt % to about 10 wt %, or about 0.1 wt % to about 5 wt %, or about 0.1 wt % to about 1 wt %, or about 1 wt % to about 10 wt %, or about 1 wt % to about 5 wt %, or about 5 wt % to about 10 wt %.

The gelled acid compositions of the present disclosure may include one or more additional additives. For example, in some embodiments, the gelled acid composition may include additives including, but not limited to, a retarding agent, a surfactant, a friction reducer, an emulsifier, a copolymer, a bactericide, an oxidizing agent, a lost circulation material, a scale inhibitor, a clay stabilizer, a corrosion inhibitor, a paraffin inhibitor, an asphaltene inhibitor, a penetrating agent, a clay control additive, an iron control additive, a reducer, an oxygen scavenger, a sulfide scavenger, a foaming agent, gases, derivatives thereof, the like, and any combination thereof.

In any embodiment, the gelled acid composition may comprise a make-up of water. Said water may be derived from any suitable source including, but not limited to, fresh water, distilled water, deionized water, non-potable water, seawater, brackish water, lake and/or pond water, produced water, the like, and any combination thereof.

Embodiments disclosed herein include:
A. Methods for acid stimulation in carbonate formations comprising: injecting a gelled acid composition having a viscosity of about 25 cP to about 40 cP into a carbonate formation, wherein the gelled acid composition comprises diammonium phosphate (DAP), an acid, a thickening agent, a crosslinker, and water; and acidizing the carbonate formation with the gelled acid composition to increase a permeability of the carbonate formation.
B. Gelled acid compositions for acid stimulation in carbonate formations comprising: diammonium phosphate (DAP); an acid; a thickening agent; a crosslinker; and water, wherein the compositions have a viscosity of about 25 cP to about 40 cP.

Each of embodiments A and B may have one or more of the following additional elements in any combination:
Element 1: wherein the acid comprises hydrochloric acid.
Element 2: wherein the thickening agent comprises a guar derivative.
Element 3: wherein the guar derivative comprises carboxymethyl hydroxypropyl guar.
Element 4: wherein the crosslinker comprises a group 4 metal crosslinker.
Element 5: wherein the group 4 metal crosslinker comprises a zirconium-based crosslinker.
Element 6: wherein the gelled acid composition has a diammonium phosphate concentration of about 1 wt % to about 20 wt %.
Element 7: wherein the gelled acid composition has an acid concentration of about 5 wt % to about 25 wt %.
Element 8: wherein the gelled acid composition has a thickening agent concentration of about 0.01 wt % to about 10 wt %.
Element 9: wherein the gelled acid composition has a crosslinker concentration of about 0.01 wt % to about 10 wt %.

By way of non-limiting example, exemplary combinations applicable to A, B and C include: 1 and 2; 1 and 4; 1 and 6; 1 and 7; 1 and 8; 1 and 9; 2 and 3; 2 and 4; 2 and 6; 2 and 7; 2 and 8; 2 and 9; 3 and 4; 3 and 6; 3 and 7; 3 and 8; 3 and 9; 4 and 5; 4 and 6; 4 and 7; 4 and 8; 4 and 9; 5 and 6; 5 and 7; 5 and 8; 5 and 9; 6 and 7; 6 and 8; 6 and 9; 7 and 8; 7 and 9; 8 and 9; 1, 2, and 3; 1, 4, and 5; 1, 6, and 7; 1, 7, and 8; 1, 8, and 9; 6, 7, and 8; and 7, 8, and 9.

The present disclosure is further directed to the following non-limiting causes:
Clause 1. A method comprising:
   injecting a gelled acid composition having a viscosity of about 25 cP to about 40 cP into a carbonate formation;
      wherein the gelled acid composition comprises:
         diammonium phosphate (DAP);
         an acid;
         a thickening agent;
         a crosslinker; and
         water; and
   acidizing the carbonate formation with the gelled acid composition to increase a permeability of the carbonate formation.
Clause 2. The method of clause 1, wherein the acid comprises hydrochloric acid.
Clause 3. The method of clause 1 or clause 2, wherein the thickening agent comprises a guar derivative.
Clause 4. The method of clause 3, wherein the guar derivative comprises carboxymethyl hydroxypropyl guar.
Clause 5. The method of any one of clauses 1-4, wherein the crosslinker comprises a group 4 metal crosslinker.
Clause 6. The method of clause 5, wherein the group 4 metal crosslinker comprises a zirconium-based crosslinker.
Clause 7. The method of any one of clauses 1-6, wherein the gelled acid composition has a diammonium phosphate concentration of about 1 wt % to about 20 wt %.
Clause 8. The method of any one of clauses 1-7, wherein the gelled acid composition has an acid concentration of about 5 wt % to about 25 wt %.
Clause 9. The method of any one of clauses 1-8, wherein the gelled acid composition has a thickening agent concentration of about 0.01 wt % to about 10 wt %.
Clause 10. The method of any one of clauses 1-9, wherein the gelled acid composition has a crosslinker concentration of about 0.01 wt % to about 10 wt %.
Clause 11. A composition comprising:
   diammonium phosphate (DAP);
   an acid;
   a thickening agent;
   a crosslinker; and
   water;
      wherein the composition has a viscosity of about 25 cP to about 40 cP.
Clause 12. The composition of clause 11, wherein the acid comprises hydrochloric acid.
Clause 13. The composition of clause 11 or clause 12, wherein the thickening agent comprises a guar derivative.
Clause 14. The composition of clause 13, wherein the guar derivative comprises carboxymethyl hydroxypropyl guar.
Clause 15. The composition of any one of clauses 11-14, wherein the crosslinker comprises a group 4 metal crosslinker.
Clause 16. The composition of clause 15, wherein the group 4 metal crosslinker comprises a zirconium-based crosslinker.
Clause 17. The composition of any one of clauses 11-16, wherein the composition has a diammonium phosphate concentration of about 1 wt % to about 20 wt %.
Clause 18. The composition of any one of clauses 11-17, wherein the composition has an acid concentration of about 5 wt % to about 25 wt %.
Clause 19. The composition of any one of clauses 11-18, wherein the composition has a thickening agent concentration of about 0.01 wt % to about 10 wt %.
Clause 20. The composition of any one of clauses 11-19, wherein the composition has a crosslinker concentration of about 0.01 wt % to about 10 wt %.

### EXAMPLES

A comparative gelled acid was prepared by gradually introducing hydrochloric acid (HCl) into deionized (DI) water while maintaining constant stirring at 1500 rpm. Once the mixture was homogenized, 0.5 g of carboxymethyl hydroxypropyl guar (CMHPG) was introduced and stirred for 15 minutes. Subsequently, 6.67 g of a zirconium alkoxide crosslinker was added and stirred for 1 minute. An example gelled acid was similarly prepared, but with the inclusion of 4.15 g of diammonium phosphate (DAP) dissolved in DI water. Table 1 shows the compositions of the comparative and example gelled acids.

TABLE 1

| | Comparative | Example |
|---|---|---|
| Component | Gelled Acid | Gelled Acid |
| HCl (wt %) | 15.00 | 15.00 |
| CMHPG (wt %) | 1.00 | 1.00 |
| Crosslinker (wt %) | 1.00 | 1.00 |
| DAP (wt %) | 0.00 | 8.30 |
| DI Water (wt %) | 83.00 | 74.7 |

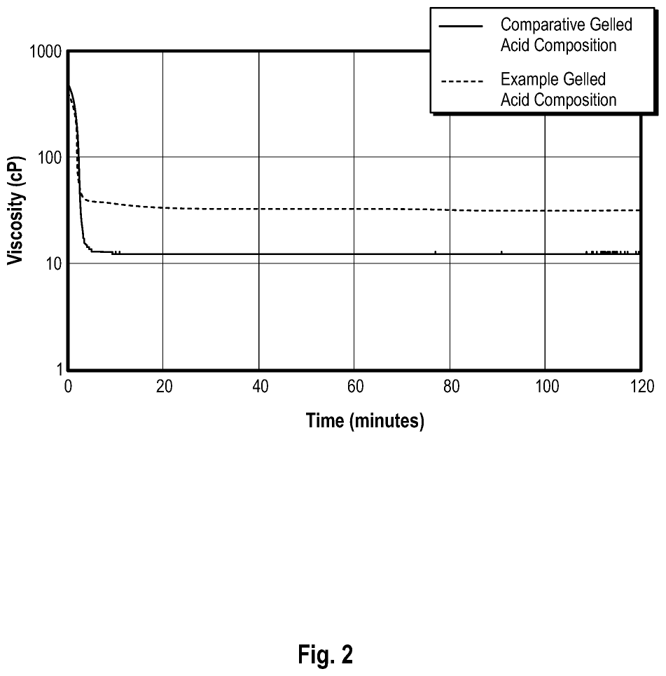

Following the preparation of the comparative and example gelled acids, the acids' viscosities were measured for 2 hours at 158° F., 500 psi, and a shear rate of 100 s⁻¹ using a HTHP 5550 viscometer (CHANDLER ENGINEERING®/AMTEK®). FIG. 2 is a graph of the time-dependent viscosities of a comparative gelled acid composition and an example gelled acid composition of the present disclosure.

A comparison between the gelled acids can be conducted based on their respective viscosities, with the comparative composition exhibiting a viscosity of 12.24 cP. Conversely, the example composition displays a significantly higher viscosity of 32.18 cP. The increased viscosity of the example gelled acid may suggest an enhanced ability to penetrate and dissolve carbonate rock formations within the reservoir. Furthermore, the heightened viscosity could improve control over the acid's placement within the formation, leading to increased contact with the rock surface. Ensuring stability over extended test periods is crucial to ensure the effective performance of gelled acids, and the results indicate that the structural strength of the example gelled acid remains stable.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method comprising:
injecting a gelled acid composition having a viscosity of about 25 cP to about 40 cP into a carbonate formation;
wherein the gelled acid composition comprises:
diammonium phosphate (DAP);
an acid;
a thickening agent;
a crosslinker; and
water; and
acidizing the carbonate formation with the gelled acid composition to increase a permeability of the carbonate formation.

2. The method of claim 1, wherein the acid comprises hydrochloric acid.

3. The method of claim 1, wherein the thickening agent comprises a guar derivative.

4. The method of claim 3, wherein the guar derivative comprises carboxymethyl hydroxypropyl guar.

5. The method of claim 1, wherein the crosslinker comprises a group 4 metal crosslinker.

6. The method of claim 5, wherein the group 4 metal crosslinker comprises a zirconium-based crosslinker.

7. The method of claim 1, wherein the gelled acid composition has a diammonium phosphate concentration of about 1 wt % to about 20 wt %.

8. The method of claim 1, wherein the gelled acid composition has an acid concentration of about 5 wt % to about 25 wt %.

9. The method of claim 1, wherein the gelled acid composition has a thickening agent concentration of about 0.01 wt % to about 10 wt %.

10. The method of claim 1, wherein the gelled acid composition has a crosslinker concentration of about 0.01 wt % to about 10 wt %.

11. A composition comprising:
diammonium phosphate (DAP);
an acid;
a thickening agent;
a crosslinker; and
water;
wherein the composition has a viscosity of about 25 cP to about 40 cP.

12. The composition of claim 11, wherein the acid comprises hydrochloric acid.

13. The composition of claim 11, wherein the thickening agent comprises a guar derivative.

14. The composition of claim 13, wherein the guar derivative comprises carboxymethyl hydroxypropyl guar.

15. The composition of claim 11, wherein the crosslinker comprises a group 4 metal crosslinker.

16. The composition of claim 15, wherein the group 4 metal crosslinker comprises a zirconium-based crosslinker.

17. The composition of claim 11, wherein the composition has a diammonium phosphate concentration of about 1 wt % to about 20 wt %.

18. The composition of claim 11, wherein the composition has an acid concentration of about 5 wt % to about 25 wt %.

19. The composition of claim 11, wherein the composition has a thickening agent concentration of about 0.01 wt % to about 10 wt %.

20. The composition of claim 11, wherein the composition has a crosslinker concentration of about 0.01 wt % to about 10 wt %.
